(19) United States
(12) Patent Application Publication
(10) Pub. No.: US 2014/0314248 A1
(43) Pub. Date: Oct. 23, 2014

(54) Wireless Headphones for Working Out

(71) Applicant: Angel Ruiz, Deltona, FL (US)

(72) Inventor: Angel Ruiz, Deltona, FL (US)

(21) Appl. No.: 14/215,307

(22) Filed: Mar. 17, 2014

Related U.S. Application Data
(60) Provisional application No. 61/814,864, filed on Apr. 23, 2013.

(51) Int. Cl. H04R 1/10

(52) U.S. Cl. CPC H04R 1/1091
USPC 381/74

(57) ABSTRACT

A wireless headphone system is disclosed that provides a hands-free and cord-free way to listen to a personal electronic device. The wireless headphone system comprises an earpiece component with an embedded wireless receiver and a headphone jack component with an embedded transmitter, wherein the transmitter and the wireless receiver are in communication with each other. The earpiece component comprises a protruding ear bud component, a curved arm component that wraps around a user's ear to secure the earpiece component in place, and a wireless receiver. The headphone jack component comprises a jack adapter component which is plugged into an electronic device to transmit music to the earpiece component, and a transmitter. The transmitter and the wireless receiver are in communication with each other to transmit signals from the headphone jack component to be received by the wireless receiver in the earpiece component.

### CROSS-REFERENCE

This application claims priority from Provisional Patent Application Ser. No. 61/814,864 filed Apr. 23, 2013.

### BACKGROUND

Headphone cords can easily tangle on equipment or clothing and can rip out of user's ears. This is not only painful, but it can also damage the headphones and the electronic device. Additionally, the coating around the cords can wear off over time. If sweat drips directly onto the exposed cords, users can get shocked. Some users may invest in traditional wireless headphones, but these headphones are big and bulky and are not conductive for physical activity. An effective solution is necessary.

The present invention wirelessly plays music from an MP3 player, smart phone, a tablet, or other electronic device, and eliminates the need for cumbersome and restricting headphone cords. The wireless headphone system also affords a full range of motion when working out or engaging in physical activity, and prevents tangled cords from snagging on equipment or clothing. The wireless headphone system benefits gym goers, athletes, and anyone looking for an easier way to listen to music.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a wireless headphone system that provides a hands-free and cord-free way to listen to a personal electronic device. The wireless headphone system comprises an earpiece component with an embedded wireless receiver and a headphone jack component with an embedded transmitter, wherein the transmitter and the wireless receiver are in communication with each other.

In a preferred embodiment, the earpiece component comprises a protruding ear bud component and a curved arm component that wraps around a user's ear to secure the earpiece component in place. Additionally, the earpiece component comprises a wireless receiver embedded within the earpiece component. The headphone jack component comprises a jack adapter component which is plugged into an electronic device to transmit music to the earpiece component, and a transmitter embedded within the headphone jack component. The transmitter and the wireless receiver are in communication with each other, to transmit signals from the headphone jack component to be received by the wireless receiver in the earpiece component. Thus, music is transmitted from the headphone jack component to the earpiece component.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a perspective view of the wireless headphone system in accordance with the disclosed architecture.

FIG. 2 illustrates a perspective view of the earpiece component positioned in a user's ear in accordance with the disclosed architecture.

FIG. 3 illustrates a perspective view of the headphone jack component positioned in an electronic device in accordance with the disclosed architecture.

FIG. 4A illustrates a perspective view of a prior art wired headphone system in use in accordance with the disclosed architecture.

FIG. 4B illustrates a perspective view of a prior art wireless headphone system in use in accordance with the disclosed architecture.

FIG. 5 illustrates a perspective view of the wireless headphone system in use in accordance with the disclosed architecture.

### DESCRIPTION OF PREFERRED EMBODIMENTS

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

The present invention wirelessly plays music from an MP3 player, smart phone, tablet, or other electronic device, and eliminates the need for cumbersome and restricting headphone cords. The wireless headphone system also affords a full range of motion when working out or engaging in physical activity, and prevents tangled cords from snagging on equipment or clothing. The wireless headphone system benefits gym goers, athletes, and anyone looking for an easier way to listen to music.

The wireless headphone system comprises an earpiece component with an embedded wireless receiver and a headphone jack component with an embedded transmitter, wherein the transmitter and the wireless receiver are in communication with each other. The earpiece component comprises a protruding ear bud component, a curved arm component that wraps around a user's ear to secure the earpiece component in place, and a wireless receiver. The headphone jack component comprises a jack adapter component which is plugged into an electronic device to transmit music to the ear piece component, and a transmitter. The transmitter and the wireless receiver are in communication with each other to transmit signals from the headphone jack component to be received by the wireless receiver in the earpiece component.

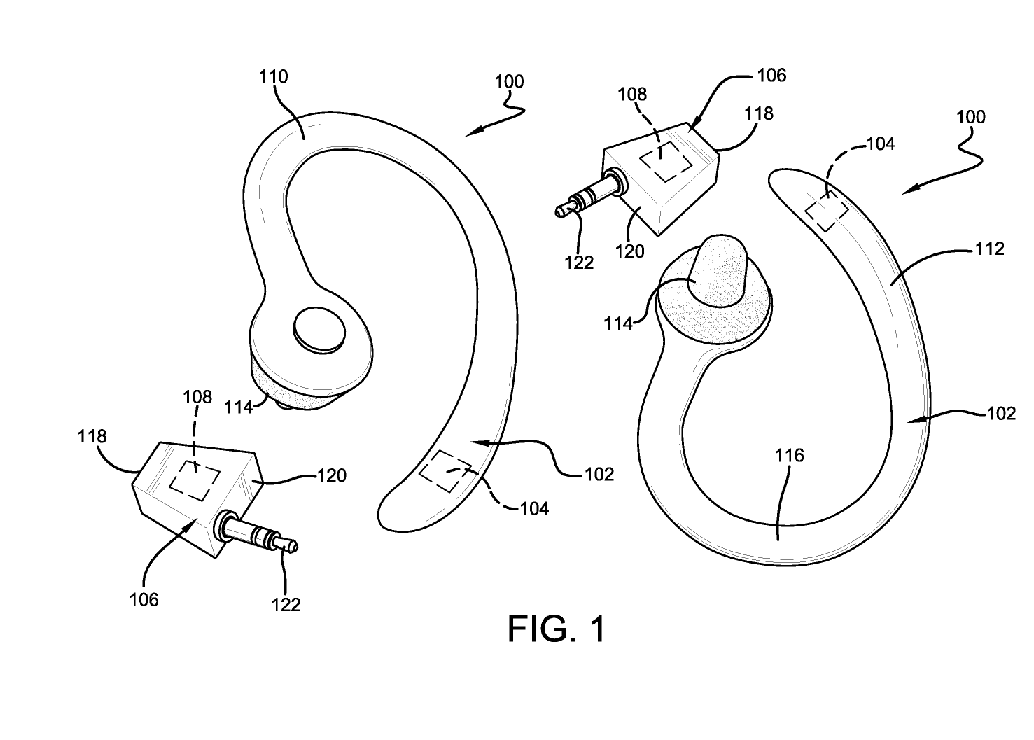

Referring initially to the drawings, FIG. 1 illustrates the wireless headphone system 100 that provides a hands-free and cord-free way to listen to a personal electronic device. The wireless headphone system 100 comprises an earpiece component 102 with an embedded wireless receiver 104 and a headphone jack component 106 with an embedded transmitter 108, wherein the transmitter 108 and the wireless receiver 104 are in communication with each other (as shown in FIG. 1).

The earpiece component 102 comprises a front surface 110 and a back surface 112 and would generally be constructed of recycled plastics, or homogeneous plastics, such as polyvinyl chloride (PVC), acrylonitrile butadiene styrene (ABS), polycarbonate (PC), composite polymers, etc., though any other suitable material may be used to manufacture the earpiece component 102 as is known in the art without affecting the overall concept of the invention. The earpiece component 102 also comprises a protruding ear bud component 114 secured to the back surface 112 of the earpiece component 102. The protruding ear bud component 114 is secured to the back surface 112 via any suitable securing means as is known in the art, such as gluing, threading, or ultrasonic welding. Typically, the protruding ear bud component 114 is made of a sweat-resistant material, such as nylon, Lycra®, or rubber; or contains a water-resistant seal. Further, the earpiece component 102 comprises a curved arm component 116 that wraps around a user's ear (not shown) to secure the earpiece component 102 in place.

Additionally, the earpiece component 102 comprises a wireless receiver 104 embedded within the ear piece component 102. The wireless receiver 104 can be any typical wireless receiver as is known in the art, and can even be a wireless transceiver, so as to receive and transmit wireless signals. Further, the earpiece component 102 can comprise a variety of colors and designs to suit user and manufacturing preference, and the shape and size of the earpiece component 102 may vary greatly depending on the wants and needs of a user.

The headphone jack component 106 of the wireless headphone system 100 comprises a top end 118 and a bottom end 120, and would generally be constructed of recycled plastics, or homogeneous plastics, such as polyvinyl chloride (PVC), acrylonitrile butadiene styrene (ABS), polycarbonate (PC), composite polymers, etc., though any other suitable material may be used to manufacture the headphone jack component 106 as is known in the art without affecting the overall concept of the invention. The headphone jack component 106 also comprises a jack adapter component 122 secured to the bottom end 120 of the headphone jack component 106. The jack adapter component 122 is plugged into an electronic device (not shown) to transmit music to the ear piece component 102. The electronic device can be any typical electronic device that plays music as is known in the art, such as a smart phone, a MP3 player, a tablet, or a cellular phone.

Additionally, the headphone jack component 106 comprises a transmitter 108 embedded within the headphone jack component 106. The transmitter 108 can be any typical transmitter as is known in the art, and can even be a wireless transceiver, so as to receive and transmit wireless signals. The transmitter 108 and the wireless receiver 104 are in communication with each other, to transmit signals from the headphone jack component 106 to be received by the wireless receiver 104 in the earpiece component 102. Thus, music is transmitted from the headphone jack component 106 to the earpiece component 102. Furthermore, the transmitter 108 and the wireless receiver 104 can communicate from a distance, allowing users to keep the electronic device safely in a gym bag or locker while they work out. Further, the headphone jack component 106 can comprise a variety of colors and designs to suit user and manufacturing preference, and the shape and size of the headphone jack component 106 may vary greatly depending on the wants and needs of a user.

Additionally, the wireless headphone system 100 can comprise other features and functions, such as a visible light source positioned on the earpiece component 102 to indicate when power is being supplied to the earpiece component 102, etc. Overall, it is a simple, effective earpiece component 102, which is flexible to make for a comfortable, universal, and secure fit, with one size fits all.

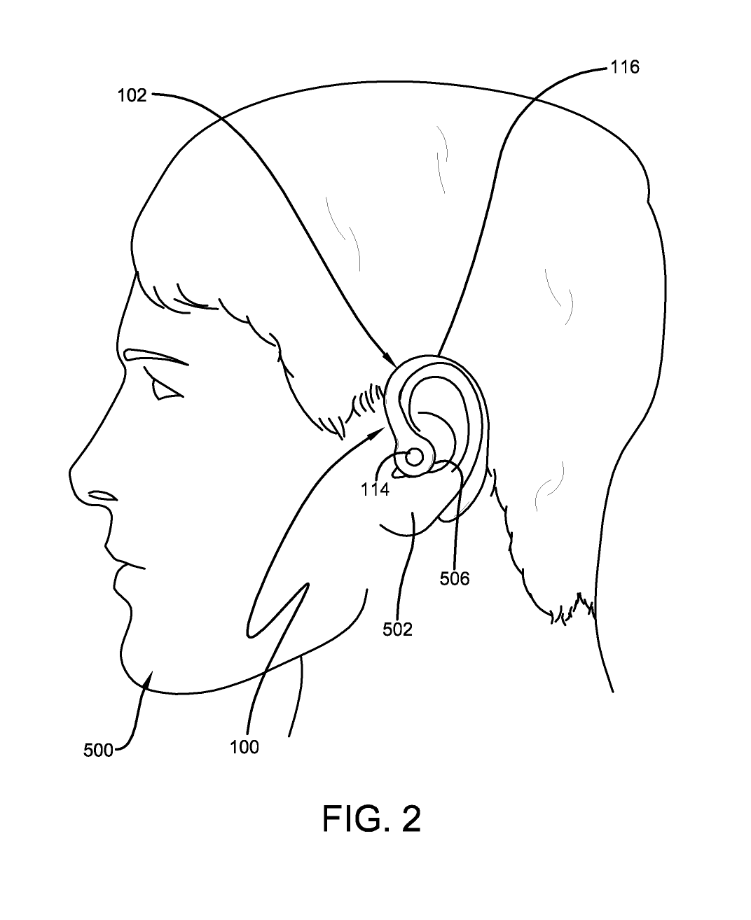

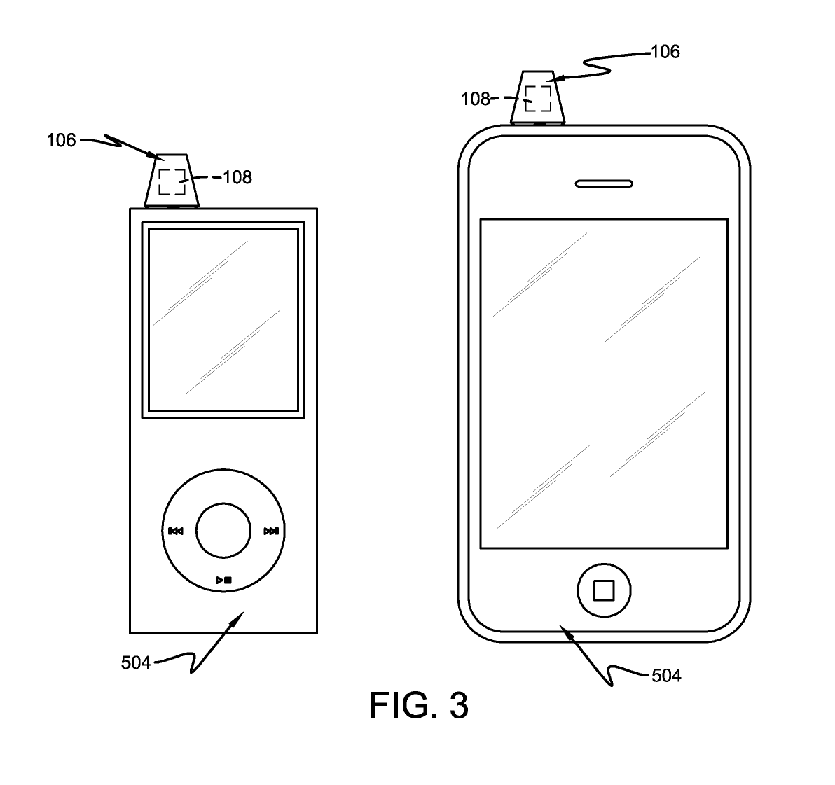

FIGS. 2-3 illustrate the ear piece component 102 positioned in a user's ear 502, and the headphone jack component 106 positioned in an electronic device 504. As stated supra, the earpiece component 102 comprises a protruding ear bud component 114 secured to the back surface 112 of the earpiece component 102. The protruding ear bud component 114 is sized to fit within the ear canal 506 of a user 500. Typically, the protruding ear bud component 114 is made of a sweat-resistant material, such as nylon, Lycra®, strong rubber, acrylic, or plastic. Further, the earpiece component 102 comprises a curved arm component 116 that wraps around a user's ear 502 to secure the earpiece component 102 in place (as shown in FIG. 2). Additionally, the earpiece component 102 comprises a wireless receiver 104 embedded within the earpiece component 102.

Further, the headphone jack component 106 of the wireless headphone system 100 comprises a jack adapter component 122 secured to the bottom end 120 of the headphone jack component 106. The jack adapter component 122 is plugged into an electronic device 504 to transmit music to the ear piece component 102 (as shown in FIG. 3). The electronic device can be any typical electronic device that plays music as is known in the art, such as a smart phone, a MP3 player, a tablet, or a cellular phone.

Additionally, the headphone jack component 106 comprises a transmitter 108 embedded within the headphone jack component 106. The transmitter 108 and the wireless receiver 104 are in communication with each other, to transmit signals from the headphone jack component 106 to be received by the wireless receiver 104 in the earpiece component 102. Thus, music can be transmitted from the headphone jack component 106 to the earpiece component 102.

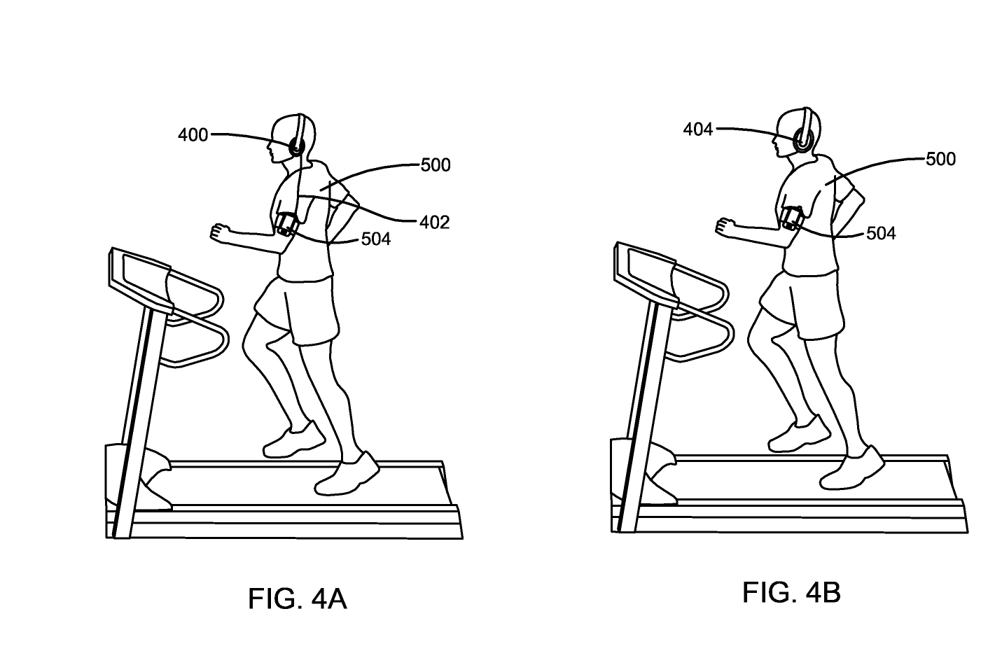

FIG. 4A illustrates a prior art wired headphone system in use. The prior art wired headphone system is any typical wired headphone system as is known in the art, and functions as a typical, prior art wired headphone system. The prior art wired headphone system comprises a typical set of headphones 400 which are connected via a wire 402 to the electronic device 504, such that a user can play music from their electronic device 504, which can then be heard through the headphones 400. These headphones 400 are not very effective during physical activity because they are big and bulky, and a user can get tangled in the wires 402 while exercising.

FIG. 4B illustrates a prior art wireless headphone system in use. The prior art wireless headphone system comprises a set of wireless headphones 404 which are in communication with the electronic device 504, such that a user can play music from their electronic device 504, which can then be heard through the headphones 404. These wireless headphones 404 are big and bulky, and typically only work with Bluetooth, thus these headphones 404 are not very effective during physical activity and are typically not made with sweat-proof material.

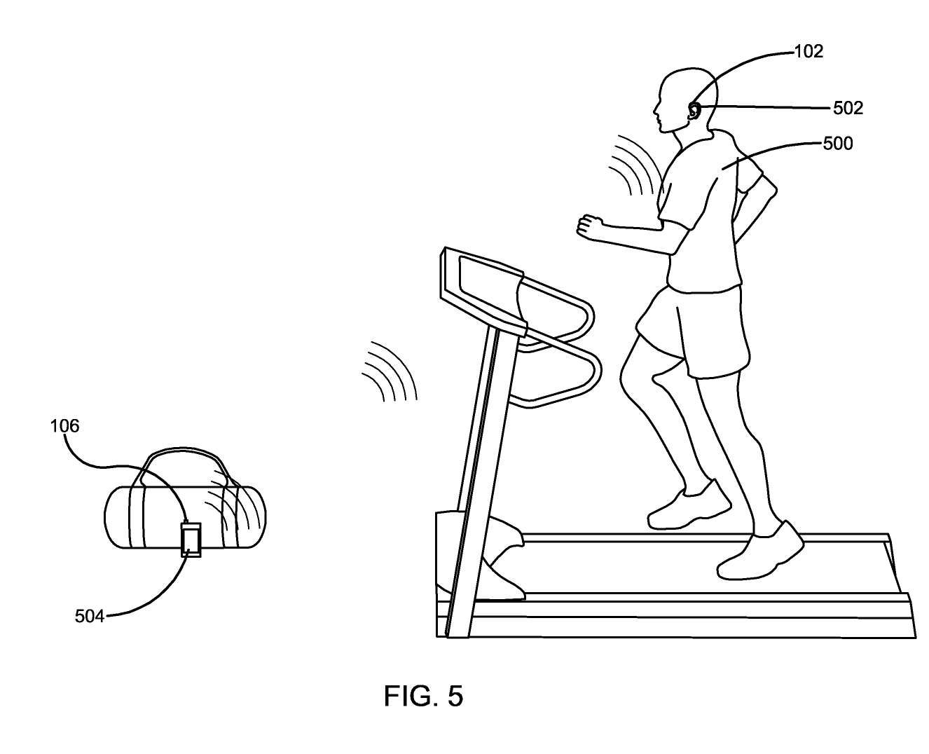

FIG. 5 illustrates the wireless headphone system 100 in use. The wireless headphone system 100 is lightweight, durable, sweat resistant, and fits securely on a user's ears so the earpiece component 102 won't fall out during physical activity. Further, the wireless headphone system 100 is universal with all electronic devices, just plug and play. As stated supra, the wireless headphone system 100 comprises an earpiece component 102 with an embedded wireless receiver 104 and a headphone jack component 106 with an embedded transmitter 108, wherein the transmitter 108 and the wireless receiver 104 are in communication with each other.

The earpiece component 102 comprises a protruding ear bud component 114, a curved arm component 116 that wraps around a user's ear 502 to secure the earpiece component 102 in place, and a wireless receiver 104. The headphone jack component 106 comprises a jack adapter component 122 which is plugged into an electronic device 504 to transmit music to the ear piece component 102, and a transmitter 108. The transmitter 108 and the wireless receiver 104 are in communication with each other to transmit signals from the headphone jack component 106 to be received by the wireless receiver 104 in the earpiece component 102.

In operation, a user 500 would choose the size and/or specific design of the wireless headphone system 100 that meets their needs and/or wants. The user 500 would then secure the earpiece component 102 to their ear 502, such that the protruding ear bud component 114 is positioned within the user's ear canal 506 and the curved arm component 116 is positioned around the user's ear 502 to secure the earpiece component 102 in place. Once secure, the user 500 would then plug the jack adapter component 122 of the headphone jack component 106 into the receptacle 508 of the user's electronic device 504.

Once the jack adapter component 122 is secured in the electronic device 504, the user can turn on the electronic device 504 and transmit wireless signals to the wireless receiver 104 of the earpiece component 102. Thus, the transmitter 108 and wireless receiver 104 are in communication and can transmit music from the headphone jack component 106 to the earpiece component 102. Thus, the wireless headphone system 100 wirelessly plays music from an MP3 player, smart phone, tablet, or other electronic device, and eliminates the need for cumbersome and restricting headphone cords, and affords a full range of motion when working out or engaging in physical activity.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A wireless headphone system, comprising:
an earpiece component comprising a front surface and a back surface;
a wireless receiver embedded within the earpiece component;
a headphone jack component comprising a top end and a bottom end; and
a transmitter embedded within the headphone jack component; and
wherein the transmitter and the wireless receiver are in communication with each other.

2. The wireless headphone system of claim 1, wherein the earpiece component comprises a protruding ear bud component secured to the back surface.

3. The wireless headphone system of claim 2, wherein the protruding ear bud component is secured to the back surface via at least one of gluing, threading, or ultrasonic welding.

4. The wireless headphone system of claim 2, wherein the protruding ear bud component is made of a sweat-resistant material.

5. The wireless headphone system of claim 1, wherein the earpiece component comprises a curved arm component that wraps around a user's ear to secure the earpiece component in place.

6. The wireless headphone system of claim 1, wherein the headphone jack component comprises a jack adapter component.

7. The wireless headphone system of claim 6, wherein the jack adapter component is plugged into an electronic device to transmit music to the ear piece component.

8. The wireless headphone system of claim 7, wherein the electronic device is at least one of a smart phone, a MP3 player, a tablet, or a cellular phone.

9. The wireless headphone system of claim 1, wherein the headphone jack component is manufactured of plastic.

10. The wireless headphone system of claim 1, wherein the earpiece component comprises a microphone, and wherein verbal utterances of a user are transmitted to the headphone jack component so that a user can verbally choose a song or a playlist.

11. The wireless headphone system of claim 1, wherein the earpiece component comprises a visible light source to indicate when power is being supplied to earpiece component.

12. A wireless headphone system, comprising:
an earpiece component comprising a front surface and a back surface;
a wireless receiver embedded within the earpiece component;
a headphone jack component comprising a jack adapter component and a transmitter embedded within the headphone jack component;
wherein the transmitter and the wireless receiver are in communication; and
wherein the jack adapter component is plugged into an electronic device to transmit music to the earpiece component.

13. The wireless headphone system of claim 12, wherein the electronic device is at least one of a smart phone, a MP3 player, a tablet, or a cellular phone.

14. The wireless headphone system of claim 12, wherein the earpiece component comprises a protruding ear bud component secured to the back surface.

15. The wireless headphone system of claim 14, wherein the protruding ear bud component is secured to the back surface via at least one of gluing, threading, or ultrasonic welding.

16. The wireless headphone system of claim 14, wherein the protruding ear bud component is made of a sweat-resistant material.

17. The wireless headphone system of claim 12, wherein the earpiece component comprises a curved arm component that wraps around a user's ear to secure the earpiece component in place.

18. A wireless headphone system, comprising:
an earpiece component comprising a protruding ear bud component, a curved arm component that wraps around a user's ear to secure the earpiece component in place, and
a wireless receiver embedded within the earpiece component;
a headphone jack component comprising a jack adapter component and a transmitter embedded within the headphone jack component;
wherein the transmitter and the wireless receiver are in communication; and
wherein the jack adapter component is plugged into an electronic device to transmit music to the earpiece component.

19. The wireless headphone system of claim 18, wherein the electronic device is at least one of a smart phone, a MP3 player, a tablet, or a cellular phone.

20. The wireless headphone system of claim 18, wherein the protruding ear bud component is secured to a back surface of the earpiece component via at least one of gluing, threading, or ultrasonic welding.
